(19) United States
(12) Patent Application Publication
(10) Pub. No.: US 2012/0170567 A1
(43) Pub. Date: Jul. 5, 2012

(54) Transmission Method

(76) Inventors: Frank Lahner, Erlangen (DE); Peter Thamm, Weinheim (DE)

(21) Appl. No.: 13/394,247

(22) PCT Filed: Aug. 16, 2010
(86) PCT No.: PCT/EP2010/061901

§ 371 Date: Mar. 5, 2012

(30) Foreign Application Priority Data
Sep. 3, 2009 (DE) 10 2009 040 035.4

(51) Int. Cl. H04W 74/04

(52) U.S. Cl. 370/345

(57) ABSTRACT

A transmission method in a wireless data bus network, wherein the method comprises data transmission cycles made of a plurality of time slots of matching length. Each time slot is thereby associated with a particular client on the data bus network exclusively for transmitting data. In accordance with the invention, an allocation duration is started for each time slot, wherein the time slot is utilizable exclusively by the associated client for transmitting data until the duration expires. Alternatively, the time slot that has become available after the allocation duration has expired can be exclusively associated with a different client on the data bus network in accordance with an allocation method for transmitting data.

### CROSS-REFERENCE TO RELATED APPLICATIONS

This is a U.S. national stage of application No. PCT/EP2010/061901 filed 16 Aug. 2010. Priority is claimed on German Application No. 10 2009 040 035.4 filed 3 Sep. 2009, the content of which is incorporated herein by reference in its entirety.

### BACKGROUND OF THE INVENTION

1. Field of the Invention

The present invention relates to data communications and, more particularly, to a transmission method in a wireless data bus network including data transmission cycles, e.g., superframes, comprising a multiplicity of time slots of matching length, wherein each time slot includes a particular associated subscriber on the data bus network exclusively for the purpose of transmitting data.

2. Description of the Related Art

Wireless data bus networks involve the use of various methods for regulating access by the communication subscribers to the time slots which are available during the data transmission cycles.

A first type involves each subscriber being granted an exclusive access right to a time slot. The time slots that are available in the data transmission cycles are thus each firmly associated with a particular subscriber. These access methods are called time-division multiplex methods or “TDMA Time Division Multiple Access”. Access methods based on this principle advantageously have not only freedom from collisions but also a deterministic cycle time, i.e., there is a maximum latency for the transmission of a message. However, the average latency is designed for the maximum possible data traffic and therefore cannot be reduced even in the event of temporarily reduced data traffic.

A second type involves the subscribers all being able to access the time slots that are available in the data transmission cycles simultaneously and to attempt to transmit data messages therein. These access methods are called “CSMA Carrier Sense Multiple Access”. In order to avoid collisions, subscribers wishing to access a time slot simultaneously initially listen to a time slot for a short waiting time to ensure that the time slot has not been engaged in the meantime by another subscriber for the purpose of transmitting a data message. If no data transmission by another subscriber can be established at the end of the waiting time, the “listening” subscriber assumes that the time slot is free and engages it by transmitting its own data. The advantage of these methods is that a low load in a wireless communication network involves very short latencies. The disadvantage is that when the load is high the latencies can become large because of possible message repetitions, and it is not possible to determine a maximum latency.

In the case of wireless data bus networks on a radio basis which are used for industrial communication, the data transmission needs to meet the requirements of determinism and realtime capability. The data transmission thus needs to have concluded early enough for it to be process compatible, i.e., the flow of a technical process is not disturbed thereby. In addition, the maximum cycles times which occur must be able to be calculated and must be as short as possible. Finally, latencies need to be as short as possible, and messages need to be transported via different communication paths with as little delay as possible.

In order to meet requirements of this kind, use is frequently made of access methods in which a TDMA method is complemented by a CSMA method. This makes it possible to combine the advantages of TDMA methods, preferably the deterministics, and of CSMA methods, preferably the short mean latencies. Such combined access methods produce only little additional communication complexity and can be used advantageously in automation and process engineering, e.g., in “energy self-sufficient sensors”, i.e., in energy-saving sensors, e.g., with a local supply of power by a battery. A combined access method is characterized in that although the time slots which are available in a data transmission cycle have a static stipulation over which subscribers are able to have the respective time slots, i.e., which subscribers are exclusively permitted to transmit data in which time slots, if one of the subscribers does not make use of its right to data transmission in the associated time slot of a data transmission cycle, for example, because there are no data for transmission, then other subscribers are able dynamically to alternately engage this time slot on a competitive basis.

### SUMMARY OF THE INVENTION

It is therefore an object of the invention to provide a method which can be used to dynamically associate a released time slot with other subscribers in this manner safely, i.e., without collisions.

This and other objects and advantages are achieved in accordance with the invention by implementing a method in a wireless data bus network, i.e., the radio network, which involves a deterministic transmission method. To this end, there is a fixed data transmission cycle comprising a multiplicity of time slots of matching length, also called a superframe. In this case, each subscriber currently registered on the data bus network has at least one firmly associated time slot in the data transmission cycle for the purpose of transmitting data. This fixed time slot can be used exclusively by the associated subscriber to transmit data. Each other subscriber is excluded from using the time slot of the associated subscriber. If data transmission is also requested by another subscriber in the meantime, this other subscriber must wait until the time slot that is associated with the subscriber itself is processed in the current data transmission cycle. Only then is the other subscriber permitted to begin the data transmission, because otherwise sending the data simultaneously with further subscribers would result in collisions. However, such a method entails those time slots that are associated exclusively with all subscribers which currently have no data to transmit remaining unused in each data transmission cycle. Although this allows a purely deterministic behavior by the data bus network, it also results in great latency. The method of the invention is used to extend such a purely deterministic time slot association as follows.

At the beginning of each time slot, the method of the invention involves an engagement period being started. The subscriber which is exclusively associated with a time slot needs to have made use of the time slot within the engagement period and needs to have begun sending data. Otherwise, this subscriber loses its right to exclusive engagement of the time slot when the engagement period elapses. If instead the engagement period elapses unused without the exclusively associated subscriber having begun sending, this time slot has effectively been released. It is now possible for other subscribers on a data bus network to attempt to engage the time slot and to use the remaining time up to the end of the time slot for an interjected data transmission with a deferred starting time. Particularly advantageously, subscribers which have a request for data transmission lend themselves to this. The method of the invention then involves the released time slot being associated using an engagement method. Examples of this are explained in more detail below.

An advantage of the method in accordance with the invention is that this retrospective engagement of a released time slot takes account of all subscribers on the data transmission network to the same degree. This also includes the subscriber that was originally exclusively associated with the time slot, and which received a request for data transmission only after the engagement period had elapsed, for example. This subscriber then has the same rights as the other subscribers when an engagement method is applied.

In accordance with an advantageous further embodiment of the invention, this engagement period begins subsequently to a waiting time after the beginning of the respective time slot. In practice, such a waiting time after the start of a time slot is frequently helpful for ensuring that switching processes in the wireless data bus network have concluded. It is thus advantageous to wait at the beginning of a time slot when the engagement period starts until all subscribers in the data transmission network have had internal process flows, particularly those conditional upon hardware processing times, concluded with certainty. An example which should be cited for these are those process flows which occur within a subscriber when switching between a sending mode and a receiving mode.

In accordance with further embodiments of the invention, it is possible to apply various engagement methods to associate the active time slot with another subscriber after the engagement period has elapsed, and in this way to allow this subscriber to perform an interjected data transmission with a deferred starting time. In the case of a first possible embodiment for an engagement method, a criterion used for selecting another subscriber is the interval of time between the released active time slot and the time slots that are exclusively associated with subscribers having a request for data transmission, i.e., subscribers wishing to send, in the data transmission cycle. It is particularly advantageous if this particular embodiment involves the released time slot being associated with that other subscriber wishing to send for which the individual exclusively allocated time slot in the data transmission cycle is still furthest away from the released time slot. In a case of this kind of engagement method, preference is thus given to that subscriber for which the longest waiting time until the appearance of the exclusively usable time slot would arise. Thus, the starting time for an interjected data transmission is brought forward for that subscriber for which the longest latency would arise in the event of a normal deterministic flow of the data transmission cycle. By contrast, all other, unselected, subscribers wishing to send experience only relative short waiting times until the exclusively associated time slot is processed, depending on the system. This deterministically results in an exclusive selection of only one of the subscribers wishing to send at all times. In addition, this selection promises maximum possible shortening of the latency on the data bus network.

In a second possible embodiment for an engagement method, a random method is used for associating one of the subscribers wishing to send with the released time slot. Here, each of the subscribers wishing to send uses a random method to determine a standalone starting time—situated in the released time slot after the engagement period has elapsed and before the end of this time slot—for possible commencement of a data transmission. Before a subscriber wishing to send actually begins the data transmission when the starting time calculated in this manner is reached, however, the wireless data bus network is checked by the subscriber. Here, it is necessary to establish whether the wireless data bus network is still unengaged, i.e., that no other subscriber wishing to send has begun transmitting data in the meantime. If this is the case, then the data transmission is begun and the time slot is engaged by this subscriber. In the presently contemplated embodiment, the released time slot is thus associated with that subscriber wishing to send that that has randomly determined a starting time which is situated closest to the end of the engagement period. When this fastest subscriber has begun the data transmission, no other subscriber wishing to send is then able to commence a data transmission. This is because when these subscribers reach the respectively calculated starting times, the checks on the wireless data bus network reveal that it is engaged and it is no longer possible to commence a data transmission in the active time slot.

In the presently contemplated embodiment, it is particularly advantageous if each subscriber wishing to send determines a starting time by multiplying a prescribed waiting time by a random number. This also results in starting times situated at different distances from the end of the engagement period, and priority is established among the subscribers wishing to send. While the waiting time, determined from the random number and the waiting time slot, is elapsing before the respective starting time is reached, each subscriber wishing to send also monitors the wireless data transmission network. When the deferred starting time is reached, the data transmission is begun—in this case too—only if the data transmission network is hitherto still unengaged, i.e., that no other subscriber wishing to send has begun a data transmission in the meantime. Only in the rare exceptional case that two subscribers wishing to send encounter the same random number by chance is a collision unavoidable. Based on the range of values for the random numbers and the length of the waiting time slot, the occurrence of such an event can be greatly reduced.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWING

The invention is explained in more detail with reference to the exemplary embodiments illustrated in the figures which are presented briefly below, in which:

FIG. 1 shows an exemplary structure of a time slot in a data transmission cycle (“superframe”) in the data transmission method in accordance with the invention;

FIG. 2a shows an exemplary time slot from FIG. 1, where time slot has been used by the exclusively associated subscriber within an engagement period for the purpose of transmitting data;

FIG. 2b shows an exemplary time slot from FIG. 2a with action periods of another subscriber, which is intended to receive the data from the exclusively associated subscriber;

FIG. 3a shows an exemplary time slot from FIG. 1, where the time slot has been used by another subscriber instead of the exclusively associated subscriber after the engagement period has elapsed for the purpose of transmitting data;

FIG. 3b shows an exemplary time slot from FIG. 3a with the action periods of a further subscriber which is intended to receive the data from the other subscriber; and

FIG. 4 is a flow chart of the method in accordance with an embodiment of the invention.

### DETAILED DESCRIPTION OF THE PREFERRED EMBODIMENTS

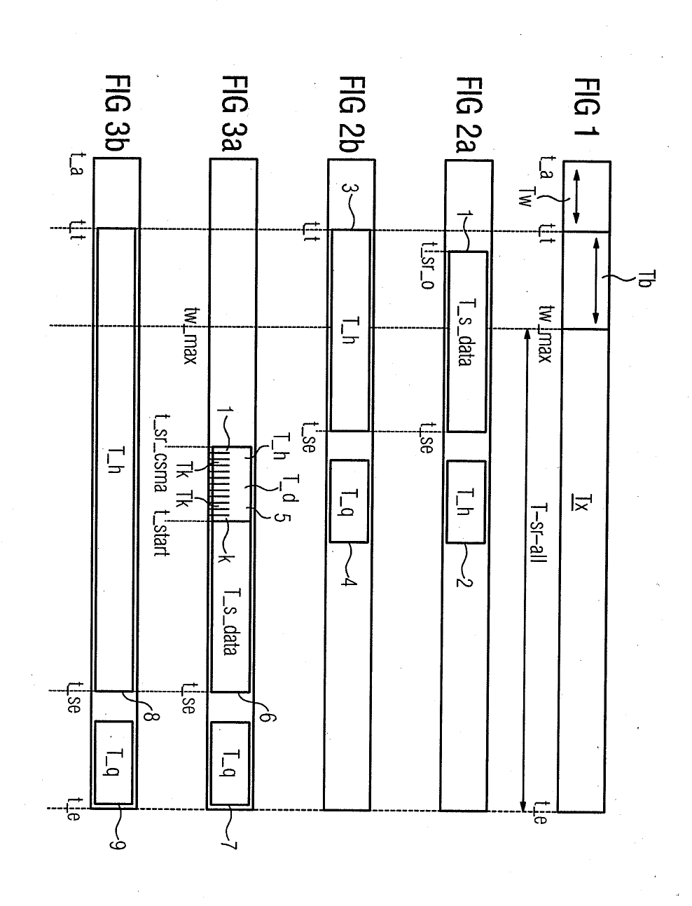

FIG. 1 shows an exemplary structure of a time slot Tx with a fixed length in a data transmission cycle which has a multiplicity of such time slices of equal length. Here, the time slot Tx with the starting time t_a and the ending time t_e has three ranges. The first range between the starting time t_a and a time t_t is a waiting time Tw. It is advantageous to await the elapsing of this waiting time Tw particularly when changing between time slots, in order to allow the hardware, particularly in the subscribers in the wireless data bus network, to switch properly between the sending and receiving states, for example. The subsequent, second range between the times t_t and tw_max is the maximum permissible engagement period Tb in accordance with the invention for the subscriber that has been exclusively allocated the time slot Tx in the superframe for the purpose of data transmission. This subscriber needs to have actually used the time slot, by beginning a data transmission, no later than when the engagement period Tb elapses at the time tw_max. Otherwise, other subscribers wishing to send can attempt to be associated with the time slot in the third range of the time slot Tx, the residual period T_sr_all, for the purpose of transmitting their own data packets. Such a transmission should, where possible, have been concluded within the residual period T_sr_all, i.e., before the time t_e is reached, however.

FIG. 2a shows an exemplary time slot Tx from FIG. 1, where the time slot has been used by the exclusively associated subscriber within the engagement period Tb for the purpose of transmitting data. To this end, this subscriber begins to transmit a data packet 1 of length T_sr_data at the time t_sr_o. In accordance with the invention, this starting time t_sr_o is within the engagement period Tb. In this way, the subscriber takes advantage of its right to exclusively engage the time slot Tx in good time and can terminate the transmission of the data packet 1 properly without disturbance by other subscribers in the data bus network at the time t_se. There then follows a reception period 2 of length T_h in which the subscriber expects the arrival of an acknowledgment message from another subscriber, which is intended to receive the data packet 1.

FIG. 2b shows an exemplary time slot Tx from FIG. 2a, with the action periods of another subscriber, which is intended to receive the data from the exclusively associated subscriber. This other subscriber is ready to receive when the waiting time Tw elapses at the time t_t, and receives the data packet 1 within the reception period 3 of length T_h. The transmission of the data packet has in turn concluded at the time t_se. There follows a sending period 4 of length T_q in which the other subscriber, which is intended to receive the data packet 1, returns an acknowledgment message about positive receipt of the data packet 1 to the holder of the time slot Tx.

FIG. 3a again shows the exemplary time slot Tx from FIG. 1. The exclusively associated subscriber has not yet begun to transmit data by the time tw_max. As a result, other subscribers can now be associated with this time slot. Instead of the exclusively associated subscriber, the time slot in FIG. 3a has therefore been used by another subscriber for the purpose of transmitting data after the engagement period Tb has elapsed. In this regard, it has been assumed in the example in FIG. 3a that at the time t_sr_csma another subscriber receives a request for transmitting a data packet 6 to a further subscriber in a data bus network, which further subscriber is intended to receive the data packet 6.

This subscriber wishing to send does not commence the data transmission immediately, however. On the contrary, it is possible for other subscribers also to have a request for data transmission. In accordance with an advantageous further embodiment of the invention, in order to associate the released time slot Tx, each other subscriber which likewise has a request for data transmission uses a random method to determine a starting time t_start, situated after the engagement period Tb and before the end t_e of the time slot Tx, for a possible data transmission.

In the example in FIG. 3a, the subscriber wishing to send has ascertained the starting time t_start via a random method, preferably at the moment t_sr_csma at which a request for data transmission was received. When this starting time is reached, the transmission of the pending data packet 6 of length T_s_data is commenced if the subscriber wishing to send can establish that the wireless data transmission network is not yet engaged at this moment. This case is assumed in FIGS. 3a and 3b.

The subscriber wishing to send thus encounters a sending delay T_d of length T_h which is caused by the randomly determined starting time t_start. This sending delay can also be used as a reception period 5 in which the subscriber wishing to send already monitors the transmission link for engagement by any subscriber in the wireless data bus system.

In accordance with a further embodiment of the invention, the deferred starting time t_start for a possible data transmission and the resultant sending delay T_d of length T_h can be determined by the subscriber wishing to send by multiplying a prescribed waiting time Tk by a random number k. The result is that the transmission of the data packet 6 of length T_s_data can be commenced by the subscriber wishing to send at the starting time t_start only if the relevant calculations of other subscribers which likewise have requests for data transmission result in a later starting time on account of a greater random number or a later arrival of a request for data transmission.

The conclusion of the transmission of the data packet 6 at a time t_se, as assumed in FIG. 3a, is again followed by a reception period 7 of length T_q in which the sending subscriber expects the arrival of an acknowledgment message from the further subscriber which is intended to receive the data packet 6.

FIG. 3b shows the exemplary time slot Tx from FIG. 3a with the action periods of this further subscriber. In this case, there is again a reception period 8 of length T_h in which the further subscriber which is intended to receive the data packet 8 is ready to receive and listens to the data transmission link for the transmission of data packets which are intended for it. This reception period 8 ends at the time t_se at the same time as the transmission of the data packet 8 concludes. There follows a sending period 9 of length T_q in which the further subscriber which is intended to receive the data packet 6 returns an acknowledgment message about positive receipt to the other subscriber. As can be seen from the examples in FIGS. 1 to 3b, all of the operations described above should, where possible, have been concluded before the ending time t_e of the time slot Tx is reached.

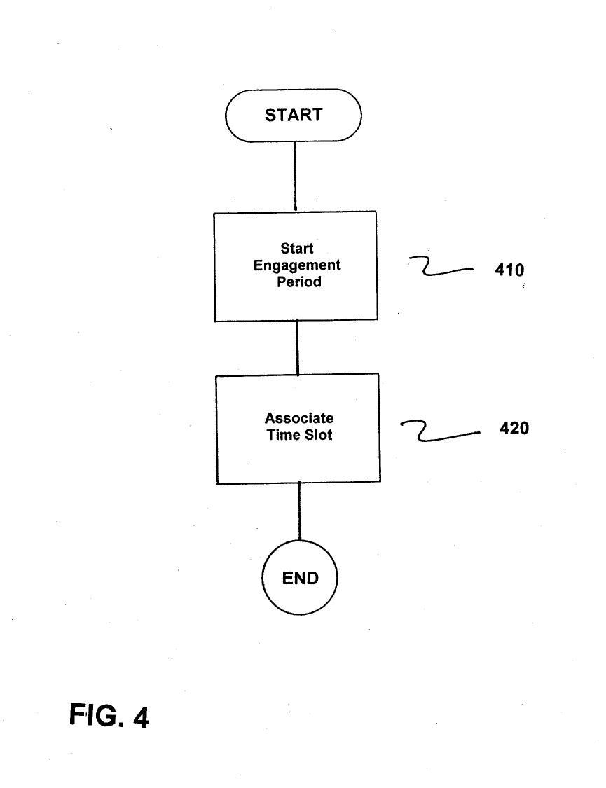

FIG. 4 is a flow chart of a transmission method in a wireless data bus network having data transmission cycles comprising a multiplicity of time slots of matching length, each time slot of the multiplicity of time slots is respectively associated with a particular associated subscriber on the wireless data bus network exclusively for transmitting data. The method comprises starting an engagement period with the one time slot of the time slots, as indicated in step 410. Here, the one time slot is engageable exclusively by the associated subscriber of the one time slot to transmit data up to expiration of the engagement period.

The one time slot, which has been released after the engagement period has elapsed, is associated exclusively with another subscriber on the data bus network based on an engagement method for transmitting the data, as indicated in step 420.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A transmission method in a wireless data bus network having data transmission cycles comprising a multiplicity of time slots of matching length, each time slot of the multiplicity of time slots is respectively associated with a particular associated subscriber on the wireless data bus network exclusively for transmitting data, the method comprising:
starting an engagement period with the one time slot of the time slots, the one time slot being engageable exclusively by the associated subscriber of the one time slot to transmit data up to expiration of the engagement period; and
associating the one time slot, which has been released after the engagement period has elapsed, exclusively with another subscriber on the data bus network based on an engagement method for transmitting the data.

9. The transmission method as claimed in claim 8, wherein the released time slot is associated exclusively with another subscriber on the data bus network which has a request for data transmission for transmitting the data.

10. The transmission method as claimed in claim 9, wherein, when there are plurality of subscribers having a request for data transmission, a criterion implemented for associating the released time slot with another subscriber comprises an interval of time between the released time slot in a data transmission cycle and time slots of the multiplicity of time slots which are associated exclusively with the subscribers having a request for data transmission.

11. The transmission method as claimed in claim 10, wherein the released time slot is associated with that other subscriber for which an associated time slot in the data transmission cycle is at a greatest interval of time from the released time slot.

12. The transmission method as claimed in claim 9, wherein, in order to associate the released time slot, each other subscriber having a request for data transmission implements a random method to determine a starting time, situated after the engagement period and before the end of the time slot, for a possible data transmission, and the data transmission is commenced if the wireless data bus network is not yet engaged when the starting time is reached.

13. The transmission method as claimed in claim 12, wherein each other subscriber having the request for data transmission determines the starting time for the possible data transmission by multiplying a prescribed waiting time by a random number.

14. The transmission method as claimed in claim 8, wherein the engagement period begins subsequent to a waiting time which is necessary after the start of the time slot up to conclusion of internal process flows on the subscribers in the data transmission network.

15. The transmission method as claimed in claim 8, wherein the data transmission cycles comprise superframes.

16. The transmission method as claimed in claim 15, wherein the internal process flows on the subscribers in the data transmission network comprises hardware processing times.
